(19) United States
(12) Patent Application Publication
(10) Pub. No.: US 2007/0024601 A1
(43) Pub. Date: Feb. 1, 2007

(54) TOUCH PEN MODULE AND RECEIVING MECHANISM THEREOF

(75) Inventors: Yu-Chen Liu, Taichung City (TW); Ting-Hsin Liao, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/459,747

(22) Filed: Jul. 25, 2006

(30) Foreign Application Priority Data
Jul. 26, 2005 (TW) 94125334

(51) Int. Cl. G09G 5/00

(52) U.S. Cl. 345/179

(57) ABSTRACT

A touch pen module is provided. The touch pen module in includes a bushing, an extending component and an elastic member. The bushing has a track disposed thereon. The track has a first fixing point and a second fixing point. The extending component has a protrusion capable of sliding with respect to the track. The elastic member is disposed between the bushing and the extending component. The protrusion is capable of sliding between the first fixing point and the second fixing point in the track. The elastic member provides a restoring force to hold the protrusion in place when the protrusion is at the first fixing point and the second fixing point.

This application claims the benefit of Taiwan application Serial No. 94125334, filed Jul. 26, 2005, the subject matter of which is incorporated herein by reference

### BACKGROUND OF THE INVENTION

1. Field of the Invention

The invention relates in general to a touch pen module, and more particularly to a press-type touch pen module capable of being received in or removed from a hand-held electronic device and a receiving mechanism thereof.

2. Description of the Related Art

Electronic devices such as mobile phones, personal digital assistants (PDAs), computers and printers and so on have been widely used nowadays and can be seen everywhere,

Of the electronic devices, examples of hand-held electronic devices include personal digital assistants and mobile phones. Many of the mobile phones and personal digital assistants are equipped with a touch pen with which the user can input and send messages or click options on the panel of a mobile phone or a personal digital assistant.

Normally, a guide track is disposed on the housing of a mobile phone or a personal digital assistant. When the user would like to use the mobile phone or the personal digital assistant, the user has to manually remove the touch pen from the guide track first, so that the user can use the touch pen to input and send messages or click options on the panel of a hand-held electronic device. However, the design of the guide track which facilitates the touch pen to be removed by hand is inconvenient to the user. Besides, the disposition of a guide track and a touch pen on the housing of a mobile phone or a personal digital assistant not only deteriorates the integral appearance of the housing of a hand-held electronic device, but also restricts the choices and versatilities in the exterior design of a hand-held electronic device. In the eyes of many users, both the practicality and the appearance of the electronic product are deteriorated, thus suppressing their purchasing desires. Consequently, the competitiveness of product is weakened, and the objective of the business is affected.

### SUMMARY OF THE INVENTION

It is therefore an object of the invention to provide a touch pen module for a hand-held electronic device and a receiving mechanism thereof. The hand-held electronic device has an integral appearance and the user is able to grab the touch pen conveniently.

The invention achieves the above-identified object by providing a touch pen module including a bushing, an extending component and an elastic member. The bushing has a track disposed thereon. The track has a first fixing point and a second fixing point. The extending component has a protrusion capable of sliding with respect to the track. The elastic member is disposed between the bushing and the extending component. The protrusion is capable of sliding between the first fixing point and the second fixing point in the track. The elastic member provides a restoring force to hold the protrusion in place when the protrusion is at the first fixing point and the second fixing point.

The invention further achieves the above-identified object by providing a receiving mechanism capable of receiving and removing a stylus of a touch pen module, The receiving mechanism includes a bushing, an extending component and an elastic member. The bushing has a track. The track has a first indented portion, a second indented portion and a third indented portion. The extending component has a protrusion capable of sliding with respect to the track. The elastic member is disposed between the bushing and the extending component for providing the extending component with an elastic restoring force. When the protrusion slides to the first indented portion, the touch pen module is at a removable state. When the protrusion slides to the third indented portion through the second indented portion, the touch pen module is at a receivable state.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a 3-D diagram of a hand-held electronic device according to a preferred embodiment of the invention;

FIG. 1B is a 3-D exploded diagram of a touch pen module;

FIG. 2A to FIG. 2D are diagrams showing the touch pen module being contracted to a contraction state from an extension state;

FIG. 2E to FIG. 2G are diagrams showing the touch pen module being restored to an extension state from a contraction state;

FIG. 3 is a diagram of a track;

FIG. 4A is a 3-D diagram showing the touch pen module being received in the main body;

FIG. 4B is a 3-D diagram showing the touch pen module being removed from the main body;

FIG. 5A is a 3-D diagram showing the assembly of the electronic device and the touch pen of the second embodiment;

FIG. 5B is an exploded 3-D diagram of a touch pen module;

FIG. 5C is a diagram showing an extending component being opened;

FIG. 5D is a diagram showing an extending component being closed; and

FIG. 5E is a diagram showing a stylus being received in an extending component.

### DETAILED DESCRIPTION OF THE INVENTION

### First Embodiment

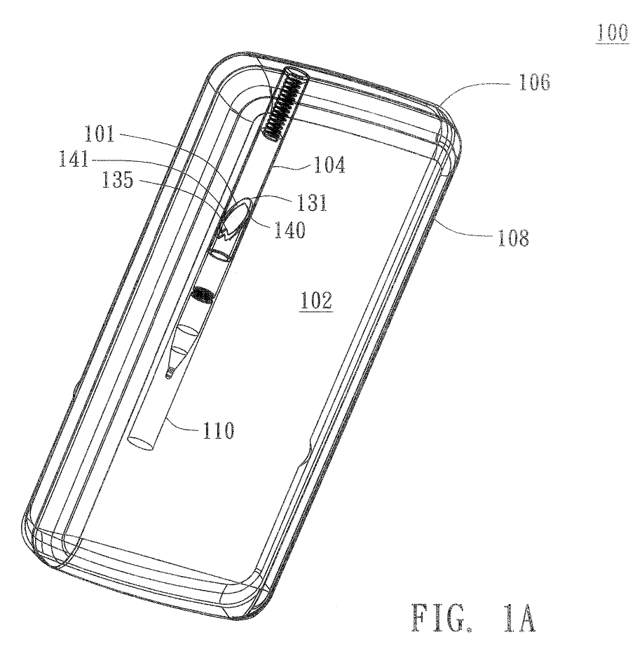

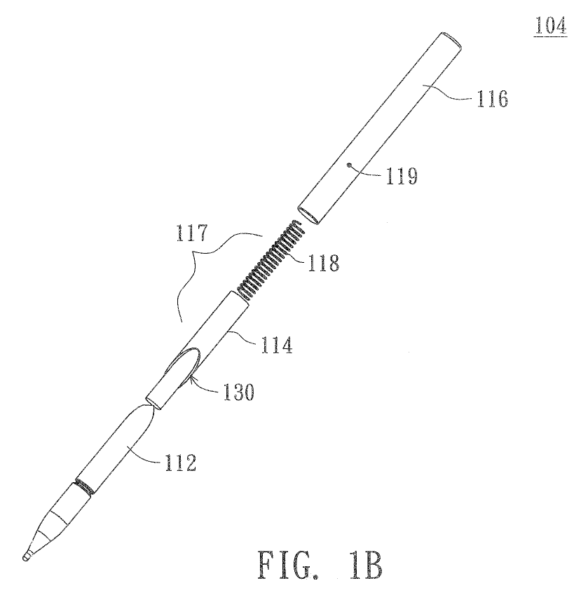

Referring to FIG. 1A, a 3-D diagram of a hand-held electronic to device according to a preferred embodiment of the invention is shown, The hand-held electronic device 100 includes a main body 102, a recess 110 and a touch pen module 104. The main body 102 includes an upper housing 106 and a lower housing 108. The recess 110 is disposed inside the main body 102 for receiving the touch pen module 104. The touch pen module 104 can be pressed to be received in or removed from the recess 110 of the main body 102.

Referring to both FIG. 1A and FIG. 1B. FIG. 1B is a 3-D exploded diagram of a touch pen module. The touch pen module 104 includes a stylus 112 and a receiving mechanism 117. The receiving mechanism 117 includes an extending component 116, an elastic member 118 and a bushing 114. The bushing 114 is mounted on the stylus 112. The bushing 114 and the stylus 112 can be integrally formed in one piece. The stylus 112 is embeddably disposed into one end of the bushing 114. The bushing 1114 has a track 130. As shown in FIG. 1A, a first fixing point 181 and a second fixing point 135 are disposed in the track 130. The extending component 1116 is mounted on the bushing 114 and slides with respect to the bushing 114. The extending component 116 having a protrusion 119 is positioned inside the track 130. The elastic member 118 has two ends which are respectively coupled to the bushing 114 and the extending component 116. The elastic member 116 provides a restoring force to hold the protrusion 119 in place when the protrusion 119 is at the first fixing point 131 and the second fixing point 135. By pressing the extending component 116 and using the elastic member 118, the protrusion 119 can slide to the first fixing point 131 and the second fixing point 135 along the track 130, so that the touch pen module 104 is at a contraction state and an extension state respectively. The track 130 includes a first track portion 140 and a second track portion 141 which are respectively coupled to the first fixing point 131 and the second fixing point 135.

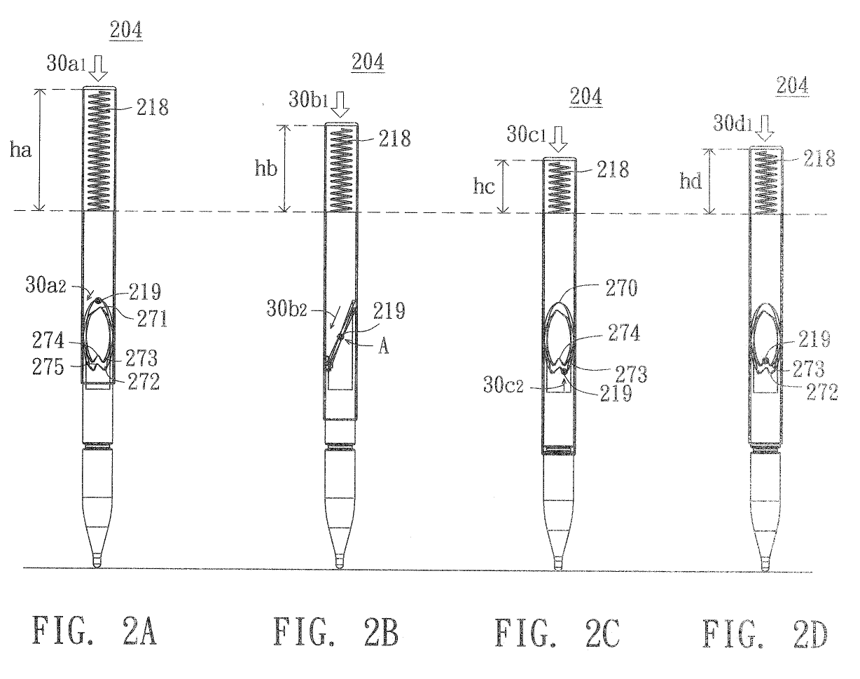

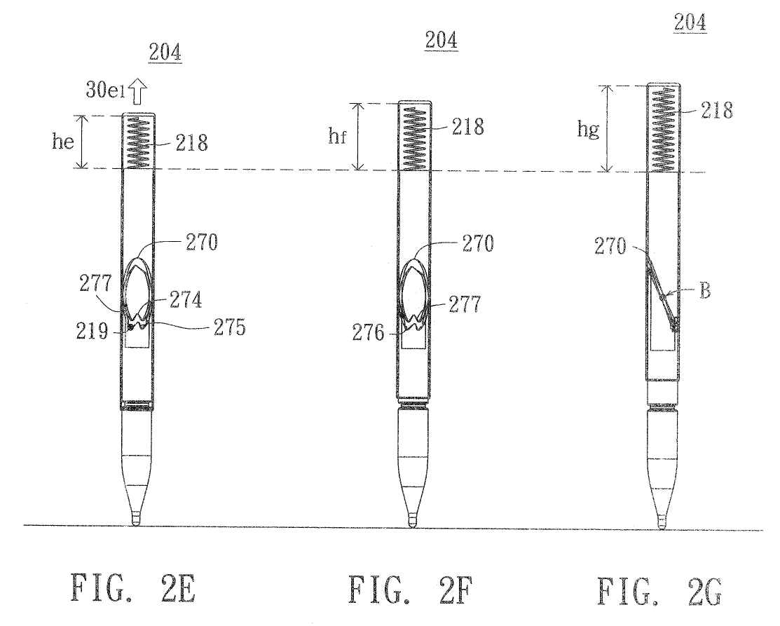

Referring to FIGS. 2A-2D, several diagrams showing the touch pen module being contracted to a contraction state from an extension state are shown. In FIG. 2A, when the user has finished using the touch pen module 204 and would like to place the touch pen module 204 back to the hand-held electronic device 100 shown in FIG. 1A, the touch pen module 204 is at an extension state like the touch pen module 104 shown in FIG. 2A, and the elastic member 218 is not compressed and has a length ha. Meanwhile the protrusion 219 is fixed at the first fixing point 131. That is, the protrusion 219 is positioned at the first indented portion 270. Meanwhile, the touch pen module 104 is at a removable state. In terms of the hand-held electronic device 100, the touch pen module 204 is positioned at a removing position of the main body of the hand-held electronic device 100. When the user applies a force on the arrow 30a1, the protrusion 219 slides to the first protruded portion 271 from the first indented portion 270. Since the adjacent first protruded portion 271 is an inclined plane, the protrusion 219 slides to the position as shown in FIG. 2B from the first protruded portion 271 along the direction of the arrow 30a2. When the user continues to press the touch pen module 204 along the direction of the arrow 30b1, the protrusion 219 continues to slide to the second indented portion 272 along the direction of the arrow 30b2. Meanwhile, the length of the elastic member 218 is hb.

In FIG. 2C, when the user continues to press the touch pen module 204 along the direction of the arrow 30c1, the protrusion 219 slides to the second protruded portion 273 from the second indented portion 272 along the direction of the arrow 30c2, When the protrusion 219 is positioned at the second indented portion 272, the length of the elastic member 218 is hc, and the touch pen module 204 has the shortest length.

In FIG. 2D, when the protrusion 219 slides to the third indented portion 274 from the second protruded portion 273, the protrusion 219 is coupled to the third indented portion 274. Meanwhile, the third indented portion 274 becomes the second fixing point. When the touch pen module 204 is positioned at a receiving position of the hand-held electronic device, the touch pen module 204 is at a contraction state, and the length of the elastic member 218 is hd. When the user does not apply a force on the touch pen module 204, the protrusion 219 is coupled to the third indented portion 274 but does not slide out along the first track portion 140. Meanwhile, the touch pen module 204 is at a receivable state.

Referring to FIGS. 2E to 2G, several diagrams showing the touch pen module being restored to an extension state from a contraction state are shown. When the user would like to use the touch pen module 204 again, the user only needs to press the touch pen module 204a along the direction of the arrow 30d1 as shown in FIG. 2D, so that the protrusion 219 slides towards the third protruded portion 275 from the third indented portion 274 first, and then the protrusion 219 slides towards the fourth indented portion 276 from the third protruded portion 275. The user no more needs to apply force on the touch pen. Availed by the restoring force of the elastic member 218, the protrusion 219 slides towards the fourth protruded portion 277, and the elastic member 218 drives the touch pen module 204 to be ejected along the direction of the arrow 30e1. The elastic member 218 is extended to the length hf as shown in FIG. 2F and the length hg as shown in FIG. 2G. When the elastic member 218 restores to the length of ha as shown in FIG. 2A, the protrusion 219 is coupled to the first indented portion 270 and becomes the first fixing point 131. In terms of the electronic device the touch pen is at a removable state.

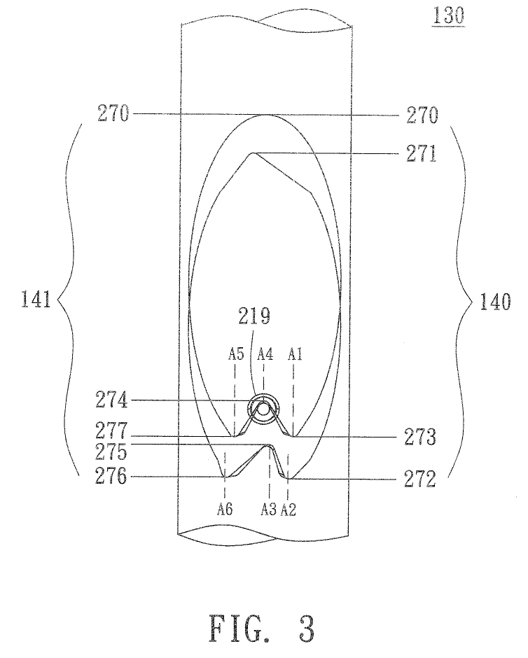

Referring to FIG. 3; a diagram of a track is shown. When the protrusion 219 is moved from the first indented portion 270 along the first track portion 140 and reaches the second indented portion 272, given that the second indented portion 272 is between the second protruded portion 273 and the third protruded portion 275 (vertical dotted line A1˜A3) and that the slope between the second indented portion 272 and the third protruded portion 275 is larger than the slope between the first indented portion 270 and the second indented portion 272, the protrusion 219 slides to the third indented portion 274 instead of returning to the first indented portion 270. Similarly, the horizontal position of the vertical line A4 of the third indented portion 274 is positioned between the third protruded portion 275 and the fourth protruded portion 277 (the vertical line A3 and A5). Meanwhile, the slope between the third indented portion 274 and the fourth protruded portion 277 is larger than the slope between the third protruded portion 275 and the fourth indented portion 277. Therefore, if the protrusion 219 is slightly moved downwardly, the protrusion 219 would still return to the position of the third indented portion 274. If the user would like to remove the touch pen module 204, the user only needs to move the protrusion 219 to be over the position of the fourth indented portion 276 (the vertical line 276), so that the protrusion 219 returns to the position of the first indented portion 270 for enabling the touch pen module 204 to be removed by the user.

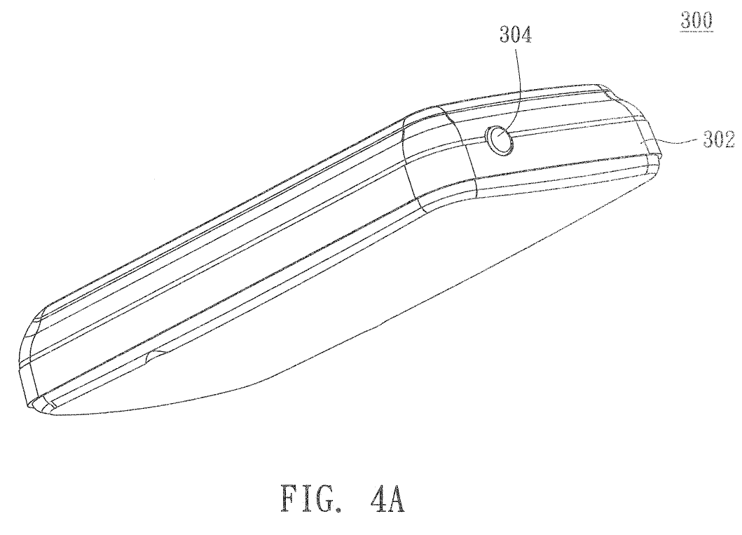

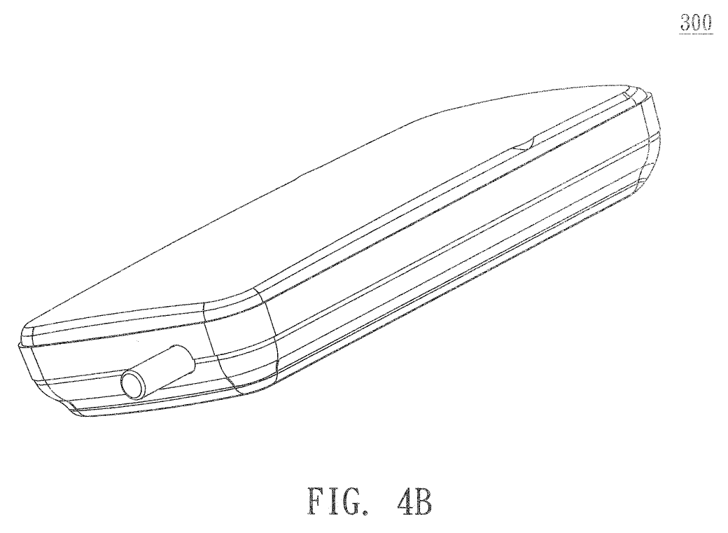

Referring to FIG. 4A and FIG. 4B. FIG. 4A is a 3-D diagram showing the touch pen module being received in the main bogy. FIG. 4B is a 3-D diagram showing the touch pen module being removed from the main body. In the hand-held electronic device 300, the touch pen module 304 can be inserted into the main body 302. As shown in FIG. 4A, the touch pen module 304 is embedded into the main body 302. Unlike the conventional hand-held electronic device whose touch pen module 304 is disposed on the surface of the main body, the main body 302 of the present embodiment of the invention is more flexible n terms of exterior design. When the user would like to remove the touch pen module 304, the user only needs to press the touch pen module 304, and then the touch pen module 304 will be prolonged and ejected for the user to use.

### Second Embodiment

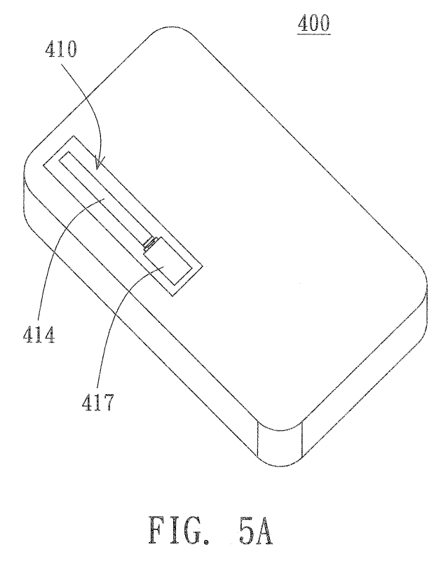

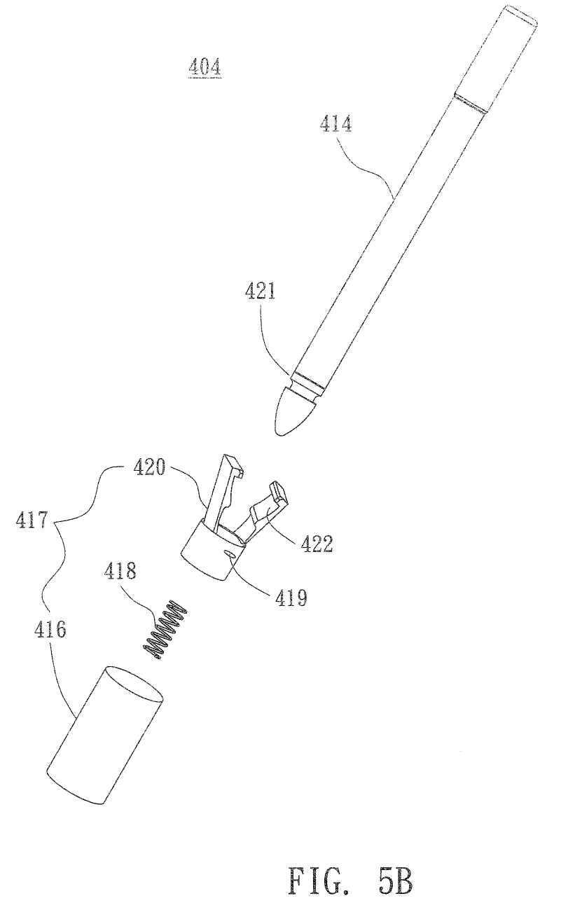

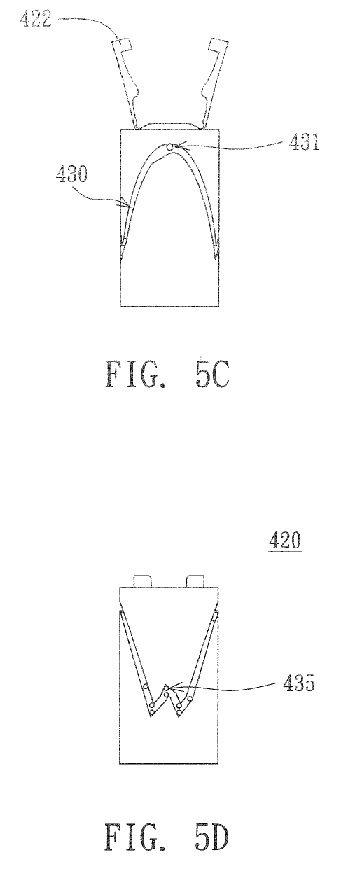

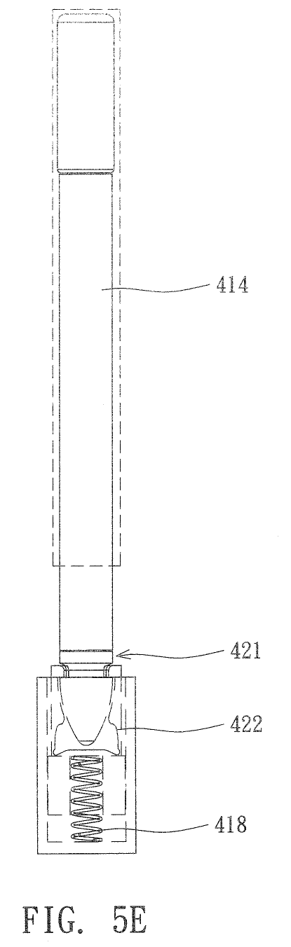

Referring to both FIG. 5A and FIG. 5B. FIG. 5A is a 3-D diagram showing the assembly of the electronic device and the touch pen of the second embodiment. FIG. 5B is an exploded 3-D diagram of a touch pen module. The second embodiment differs with the first embodiment in that the receiving mechanism 417 of the touch pen module is disposed inside the recess 410. In the present embodiment of the invention, the receiving mechanism 417 of the electronic device 400, a mobile phone for instance, includes a bushing 416, an elastic member 418 and an extending component 420. The track 430 is disposed on the bushing 416. The stylus 414 has a groove 421. The catching portion 422 of the extending component 420 is Y-shaped for catching and coupling with the groove 421. When the user presses the stylus 414, the protrusion 419 disposed on the extending component 420 slides in the track 430 of the bushing 416. In the present embodiment of the invention, the way Of sliding is the same with the first embodiment. Referring to FIG. 5C, FIG. 5D and FIG. 5E at the same time, FIG. 5C is a diagram showing an extending component being opened FIG. 5D is a diagram showing an extending component being closed, FIG. 5E is a diagram showing a stylus being received in an extending component. When the protrusion 419 of the bushing 416 is positioned at the first fixing point 431 (the first indented portion), the extending component 420 is at an open state; meanwhile, the elastic member 418 is not compressed. When the stylus 414 is received in the extending component 420, the extending component 420 slides to the second fixing point 435 (the third indented portion) from the first fixing point 431 along the bushing 416, and the elastic member 418 is compressed for storing the elastic restoring force. Meanwhile, the extending component 420 is closed to catch the groove 421 of the stylus 414, so that the stylus 414 is fixed and that the touch pen module 404 is received in the electronic device. Like the first embodiment, the stylus 414 will be released if the user presses the stylus 414 for enabling the protrusion 419 to return to the first fixing point 431 from the second fixing point.

The design of the touch pen module capable of being received in and removed from a hand-held electronic device when the touch pen is pressed is disclosed in the above embodiments of the invention. The aforementioned designs not only make it convenient for the user to receive the touch pen into or remove the tough pen from the main body, but also maintain the integral appearance of the main body, Thus the designers of the exterior design of the hand-held electronic device are given a wider range of flexibilities, and the consumers are given a wider range of choices. Consequently, the competitiveness of product is strengthened, and the objective of the business is enhanced,

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch pen module, comprising:
a bushing having a track disposed thereon, the track having a first fixing point and a second fixing point;
an extending component, having a protrusion, capable of sliding with respect to the track; and
an elastic member disposed between the bushing and the extending component;
wherein the protrusion is capable of sliding between the first fixing point and the second fixing point in the track, and the elastic member provides a restoring force to hold the protrusion in place when the protrusion is at the first fixing point and the second fixing point.

2. The touch pen module according to claim 1, further comprising a stylus having a groove, and the extending component having a catching portion for coupling with the groove.

3. The touch pen module according to claim 1, further comprising a stylus coupled to the bushing.

4. The touch pen module according to claim 3, wherein when the protrusion is at the first fixing point, the touch pen module is at a contraction state and the elastic member is compressed, and when the protrusion is at the second fixing point, the touch pen module is at an extension state and the elastic member is extended.

5. The touch pen module according to claim 4, wherein the track comprises a first track portion and a second track portion, and the first track portion and the second track portion are each coupled to toe first fixing point and the second fixing point.

6. The touch pen module according to claim 5, wherein the first track portion comprises a first indented portion, a first protruded portion, a second indented portion and a second protruded portion, the second track portion comprises a third indented portion, a third protruded portion, a fourth indented portion and a fourth protruded portion, the first indented portion is the first fixing point, and the third indented portion is the second fixing point.

7. The touch pen module according to claim 6, wherein the apex of the second indented portion is between the second protruded portion and the third protruded portion.

8. The touch pen module according to claim 7, wherein the apex of the third indented portion is between the second protruded portion and the third protruded portion.

9. The touch pen module according to claim 8, wherein the apex of the fourth protruded portion is between the third indented portion and the fourth indented portion.

10. The touch pen module according to claim 5, wherein when the touch pen module changes to the contraction state from the extension state, the protrusion slides to the second fixing point from the first fixing point along the first track portion.

11. The touch pen module according to claim 5, wherein when the touch pen module changes to the extension state from the contraction state, the protrusion slides to the first fixing point from the second fixing point along the second track potion.

12. A receiving mechanism of a touch pen module capable of receiving or removing a stylus of the touch pen module, wherein the receiving mechanism comprises:
a bushing having a track, wherein the track has a first indented portion, a second indented portion and a third indented portion;
an extending component, having a protrusion capable of sliding with respect to the track; and
an elastic member, disposed between the bushing and the extending component, for providing the extending component with an elastic restoring force;
wherein when the protrusion slides to the first indented portion, the touch pen module is at a removable state, and when the protrusion slides to the third indented portion through the second indented portion, the touch pen module is at a receivable state.

13. The receiving mechanism according to claim 12, wherein the extending component has a catching portion, the stylus has groove, and the catching portion is coupled with the groove.

14. The receiving mechanism according to claim 12, wherein the stylus has a first fixing point and a second fixing point,
wherein, by pressing the extending component, the protrusion slides to the first fixing point and the second fixing point along the track so that the touch pen module is at a contraction state and an extension state respectively, when the protrusion is at the first fixing point, the elastic member is compressed, and when the protrusion is at the second fixing point, the elastic member is extended.

15. The receiving mechanism according to claim 14, wherein the track comprises a first track portion and a second track portion, the first track portion and the second track portion are each coupled to the first fixing point and the second fixing point.

16. The receiving mechanism according to claim 15, wherein the first track portion comprises the first indented portion, a first protruded portion, the second indented portion and a second protruded portion, the second track portion comprises the third indented portion, a third protruded portion, a fourth indented portion and a fourth protruded portion, the first indented portion is the first fixing point, and the third indented portion is the second fixing point.

17. The receiving mechanism according to claim 16, wherein the apex of the second indented portion is between the second protruded portion and the third protruded portion.

18. The receiving mechanism according to claim 17, wherein the apex of the third indented portion is between the second protruded portion and the third protruded portion.

19. The receiving mechanism according to claim 18, wherein the apex of the fourth protruded portion is between the third indented portion and the fourth indented portion.

20. The receiving mechanism according to claim 15, wherein when the touch pen module changes to the contraction state from the extension state, the protrusion slides to the second fixing point from the first fixing point along the first track portion.
